(19) United States
(12) Patent Application Publication
(10) Pub. No.: US 2004/0213607 A1
(43) Pub. Date: Oct. 28, 2004

(54) Cleaning blade, cleaning device, process cartridge, and image forming apparatus using them

(75) Inventors: Yasuyuki Ishii, Shizuoka (JP); Masato Koyanagi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/765,856

(22) Filed: Jan. 29, 2004

(30) Foreign Application Priority Data
Jan. 31, 2003 (JP) 2003-023428(PAT.)
May 30, 2003 (JP) 2003-155216(PAT.)
Jan. 23, 2004 (JP) 2004-015603(PAT.)

(51) Int. Cl. G03G 21/00

(52) U.S. Cl. 399/346; 399/350

(57) ABSTRACT

In the present invention, a cleaning blade is provided, for removing remaining developer on an electrophotographic photosensitive body used for an image, forming apparatus comprises an abutment portion that abuts on the electrophotographic photosensitive body, lubricant including insulating particles and conductive particles being coated on the abutment portion, wherein a particle size of each of the insulating particles at D50 by a volume regarded as a reference lies in a range of 0.2 to 1.0 μm and a particle size of each of the conductive particles at D50 by a volume regarded as a reference lies in a range of 0.4 to 4.0 μm, the D50 being defined by that integration of volumes of particles calculated from a smaller particles size side arrives at 50% with relative to a total integration thereof, and so on.

### FIELD OF THE INVENTION AND RELATED ART

The present invention relates to an image forming apparatus, a process cartridge, a cleaning device, and a cleaning blade used for the image forming apparatus.

The “image forming apparatus” is defined by an apparatus for forming an image onto a recording medium using an electrophotographic image forming process, and for example includes an electrophotographic copier, an electrophotographic printer (such as a laser printer and LED printer), a facsimile, a word processor, and so on.

Also the “process cartridge” is defined by a cartridge that is detachably attached to a body of the image forming apparatus, allowing an electrophotographic photosensitive body and the cleaning device for cleaning the electrophotographic photosensitive body to be integrally accommodated in the cartridge.

Also the “cleaning device” is defined by a device having the cleaning blade for removing a remaining developer on the electrically photosensitive body and a developing reception part in which the developer removed by the cleaning blade is received.

Recently a conductive roller contact charging method is realized. Some merits are verified such that this method does not need a large power supply because of a low voltage activation, and does not especially need a cleaning unit for a charging device.

The conductive roller contact charging method is a method that a conductive charging member is made to be abutted on an object to be charged and thus a voltage is applied thereto, by which discharging is performed in a gap between the charging member and the object to be charged, resulting in that a required charging potential is obtained on the object to be charged.

There are an AC charging method and a DC charging method as the contact charging method. The AC charging method allows a charging condition to be even by applying a voltage obtained by interposing a DC current corresponding to a charging potential with an AC voltage thereto. The DC charging method allows a charging condition to be even by applying a voltage obtained by adding a charging potential to a discharging start-voltage thereto.

Next an explanation will be described about a conventional cleaning device. Generally speaking, in the conventional cleaning device used for an electrophotographic image forming apparatus, a cleaning roller is rotated, abutting on a photosensitive body, or a cleaning blade as a cleaning member is abutted thereon, resulting in that remaining toner (developer) having not been transferred is scratched off, thus removing such remaining toner from the photosensitive body.

Especially in an electrophotographic image forming apparatus being a process cartridge typed, in view of an advantage that its construction is simple and its cost is not expensive, etc., a cleaning blade made of urethane rubber is often used when pressing and abutting on a photosensitive body in a counter direction of the photosensitive body.

However, in a case where the cleaning blade 1s used, if a frictional force becomes large while the cleaning blade is sliding on the photosensitive body, then so to speak “blade-detachment” phenomenon will occur that the cleaning blade is turned over.

There are few cases where blade-detachment occurs because toner is functioned as a lubricant in a state where the toner exists on an edge of the cleaning blade. However, in an initial using term of the main body or the process cartridge, the toner does not exist on the edge, resulting in that frequency of occurrence of the blade-detachment is enhanced.

Therefore, conventionally in such an initial using term, powder is coated on an edge of a cleaning blade thereby having adopted a method that a friction between a photosensitive body in the initial state and the cleaning blade can be reduced.

Following properties for such powder are required. The powder has an effective particle-size for prevention of blade-detachment and is easy to be dispersed into solvent upon coating and has a splendid anti-solvent. Thus, powder made of silicon resin fine power being insulating, whose trade name is “Tospearl” produced by GE TOSHIBA SILICONE Co.) is mainly used. The particle size of the silicone resin fine powder is 0.2 to 1.0 μm.

HFE (hydrofluoroether) having splendid dispersing and coating property is used as a solvent when the above-mentioned silicone-resin fine powder is coated on an edge of a cleaning blade. Therefore the silicone resin fine powder is widely used as a coating agent for the cleaning blade because the silicone resin fine powder is not solved by HFE (refer to U.S. Pat. No. 5,819,147).

However, when such a silicone resin fine powder is coated on the cleaning blade as a cleaning member abutting on a photosensitive body using the above-mentioned contact charging method type charging device because of restriction of construction of an electrophotographic image forming apparatus, a contact charging member needs to be arranged at a downstream side rather than the cleaning blade in the apparatus and also in a direction of motion of the photosensitive body.

As a result, there have been a problem that the silicon resin powder which has passed through under the cleaning blade and which has been extraordinarily coated on the cleaning blade will be attached to a contact charging member at the downstream side.

### SUMMARY OF THE INVENTION

An object of the present invention is to provide a cleaning blade, a cleaning device, a process cartridge, and an image forming apparatus using them, which can prevent the cleaning blade from be detached by motion of an electrophotographic photosensitive body.

Also, another object of the present invention is to provide a cleaning blade, a cleaning device, a process cartridge, and an image forming apparatus using them, in which adhesiveness was enhanced between the cleaning blade and insulating particles that was coated on an abutment portion of the cleaning blade and the abutment portion is a portion that abuts on the electrophotographic photosensitive body.

Also, another object of the present invention is to provide a cleaning blade, a cleaning device, a process cartridge, and an image forming apparatus using them, which can prevent that an electrophotographic photosensitive body is destined not to be sufficiently charged by a charging roller by attaching insulating particles coated on an abutment portion of the cleaning blade that abuts on the electrophotographic photosensitive body, to the electrophotographic photosensitive body.

Also, another object of the present invention is to provide a cleaning blade including an abutment portion of the cleaning blade that abuts on an electrophotographic photosensitive body, lubricant including insulating particles and conductive particles is coated on the abutment portion, and wherein a particle size of each of the insulating particles at D50 by a volume regarded as a reference (volume reference) lies in a range of 0.2 to 1.0 μm and a particle size of each of the conductive particles at D50 by a reference volume lies in a range of 0.4 to 4.0 μm, the D50is defined by that integration of volumes of particles calculated from a smaller particles size side arrives at 50% with relative to a total integration thereof.

Also, another object of the present invention is to provide a cleaning device used for an image forming apparatus that comprises: a cleaning blade for removing the remaining developer on the electrophotographic photosensitive body; and an abutment portion that abuts on the electrophotographic photosensitive body, lubricant including insulating particles and conductive particles is coated on the abutment portion, wherein a particle size of each of the insulating particles at D50 by a volume regarded as a reference lies in a range of 0.2 to 1.0 μm and a particle size of each of the conductive particles at D50 by a volume regarded as a reference lies in a range of 0.4 to 4.0 μm, the D50 being defined by that integration of volumes of particles calculated from a smaller particles size side arrives at 50% with relative to a total integration thereof.

Also another object of the present invention is to provide a process cartridge attachable to a body of an image forming apparatus that comprises: an electrophotographic photosensitive body; a charging means for working on the electrophotographic photosensitive body; a cleaning blade for removing the remaining developer on the electrophotographic photosensitive body; and an abutment portion that abuts on the electrophotographic photosensitive body, lubricant including insulating particles and conductive particles is coated on the abutment portion, wherein a particle size of each of the insulating particles at D50 by a volume regarded as a reference lies in a range of 0.2 to 1.0 μm and a particle size of each of the conductive particles at D50 by a volume regarded as a reference lies in a range of 0.4 to 4.0 μm, the D50 being defined by that integration of volumes of particles calculated from a smaller particles size side arrives at 50% with relative to a total integration thereof.

Also another object of the present invention is to provide an image forming apparatus for forming an image or a recording medium that comprises: (i) a cleaning device used for the image forming apparatus having a cleaning blade for removing the remaining developer on the electrophotographic photosensitive body; and an abutment portion that abuts on the electrophotographic photosensitive body, lubricant including insulating particles and conductive particles is coated on the abutment portion, wherein a particle size of each of the insulating particles at D50 by a volume regarded as a reference lies in a range of 0.2 to 1.0 μm and a particle size of each of the conductive particles at D50 by a volume regarded as a reference lies in a range of 0.4 to 4.0 μm, D50 being defined by that integration of volumes of particles calculated from a smaller particles size side arrives at 50% with relative to a total integration thereof; and (ii) a carrying means for carrying the recording medium.

Also another object of the present invention is to provide an image formation apparatus for forming an image onto a recording medium to which a process cartridge is attachable that comprises: (i) an attachment portion detachably attached to a process cartridge; (ii) the process cartridge attached to the attachment portion that includes an electrophotographic photosensitive body; a charging means for working on the electrophotographic photosensitive body; a cleaning blade for removing the remaining developer on the electrophotographic photosensitive body; and an abutment portion that abuts on the electrophotographic photosensitive body, lubricant including insulating particles and conductive particles is coated on the abutment portion,wherein a particle size of each of the insulating particles at D50 by a volume regarded as a reference lies in a range of 0.2 to 1.0 μm and a particle size of each of the conductive particles at D50 by a volume regarded as a reference lies in a range of 0.4 to 4.0 μm, the D50 being defined by that integration of volumes of particles calculated from a smaller particles size side arrives at 50% with relative to a total integration thereof; and (iii) A carrying means for carrying the recording medium.

### BRIEF DESCRIPTION OF DRAWINGS

FIG. 1 is a schematic section of an image forming apparatus relating of the present embodiment.

FIG. 2 is an explanation view of a cleaning blade relating to the present embodiment.

FIG. 3 is an explanation view illustrating a sliding condition of the cleaning blade against a photosensitive drum relating to the present embodiment.

FIG. 4 is a table showing a relationship between adhesiveness of lubricant and detachment of the cleaning blade upon blending of a reduction-process type tin oxide having a value of resistance being not more than 10⁵ Ωcm relating to the present embodiment.

FIG. 5 is a view illustrating a particle distribution after 72 hours elapse after coated in a case where only Tospearl is coated thereon.

FIG. 6 is a view illustrating a particle distribution after 72 hours elapse after coated in a case of that a ratio by weight of an additive amount of a reduction-process type tin oxide having a value of resistance being not more than 10⁵ Ωcm to an amount of Tospearl=4 to 6.

FIG. 7 is a table showing a relationship between adhesiveness of lubricant and detachment of the cleaning blade upon blending of a reduction-process type tin oxide having a value of resistance being not more than 10⁵ Ωcm, in comparison with the present invention relating to the present embodiment.

### DETAILED DESCRIPTION OF THE PREFERRED EMBODIMENTS

Hereinafter the preferred embodiments of the present invention will be explained illustratively in detail, referring to the drawings. However, the scope of the present invention is not merely limited by dimension, material, shape, and relative arrangement described in this preferred embodiments as long as there is no especially specific description.

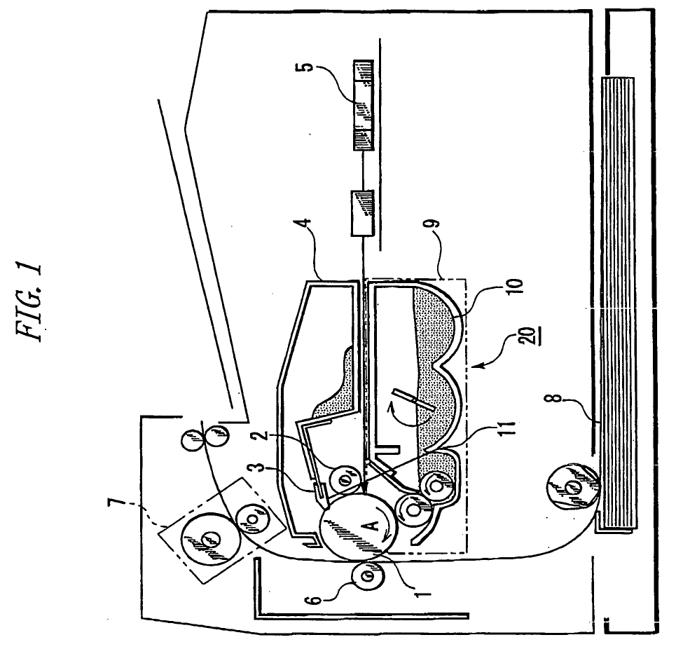

FIG. 1 is a schematic section of an image forming apparatus relating of the present embodiment. A whole configuration of the image forming apparatus of the present embodiment will be explained using FIG. 1.

In FIG. 1, a photosensitive drum 1 (Φ 30 mm) is rotated by 1 r.p.s. in an arrow A direction. The photosensitive drum 1 is evenly charged at a dark potential −600 V by a charging roller 2 as a charging means to which a D.C. voltage −1150 V is applied.

And an electrostatic latent image is written into the photosensitive drum 1 with a laser beam to be introduced from a laser scanner 5 as an exposure means. A laser power of the laser beam introduced from the laser scanner 5 is adjusted so as to have −150V when the laser beam is exposed over a whole surface.

The laser scanner 5 is inputted to the image forming apparatus. A laser beam that has been ON/OFF-controlled according to an image signal to be produced within an inside of a main body of the apparatus such as a test pattern, is irradiated onto the photosensitive drum 1, and an electrostatic latent image is formed on the photosensitive drum 1.

Such an electrostatic latent image is developed using toner 10 by a developing device 9 as a developing means arranged in the vicinity of the photosensitive drum 1, resulting in that the electrostatic latent image will be visible as a toner image. Note that in the present embodiment, so to speak, a reversal development is performed for forming the toner image at an exposure part exposed by the laser beam.

The toner image that has been visible on the photosensitive drum 1 is transferred to the recording medium 8 by a transfer roller 6 as a transfer means.

Also a fixing device 7 as a fixing means at a downstream side of the apparatus fixes a recording medium on which the toner image has been transferred.

Here, a remaining and transferred toner on the photosensitive drum 1 that has not been transferred is scratched by a cleaning blade 3 as a cleaning member of the cleaning device 4 and accommodated within a cleaning device 4. And the photosensitive drum 1 that has been cleaned repeats the above-mentioned image forming process. A tip part of the cleaning blade 3 used here is rectangular, and thickness at a base side of the cleaning blade 3 is thicker than that at the tip part side thereof.

Note that in the present embodiments, the process cartridge method is used in which the above-mentioned photosensitive drum 1, charging roller 2, developing device 9, and cleaning device 4 are integrally formed, resulting in that the integrally formed configuration is constituted as the process cartridge 20, which can be attachable to and detachable from the image forming apparatus.

Because this process cartridge method is adopted, maintenance of the image forming apparatus becomes easy. Namely, when toner becomes empty in the developing device 9, the photosensitive drum 1 and the charging roller 2 can be replaced together. Also a transferred and remaining toner built up in the cleaning device 4 can be simultaneously discarded. As a result a user of the image forming apparatus has only to replace the process cartridge 20 by a new one and thus can do simultaneously various processes together, resulting in that its maintenance becomes easy and a splendid image can be continuously obtained.

Also, because of the process cartridge method, the cleaning blade 3 is simply constituted and the cost can be reduced using a urethane-rubber-made tip blade.

Now, description will be explained about the cleaning blade 3 in more detail.

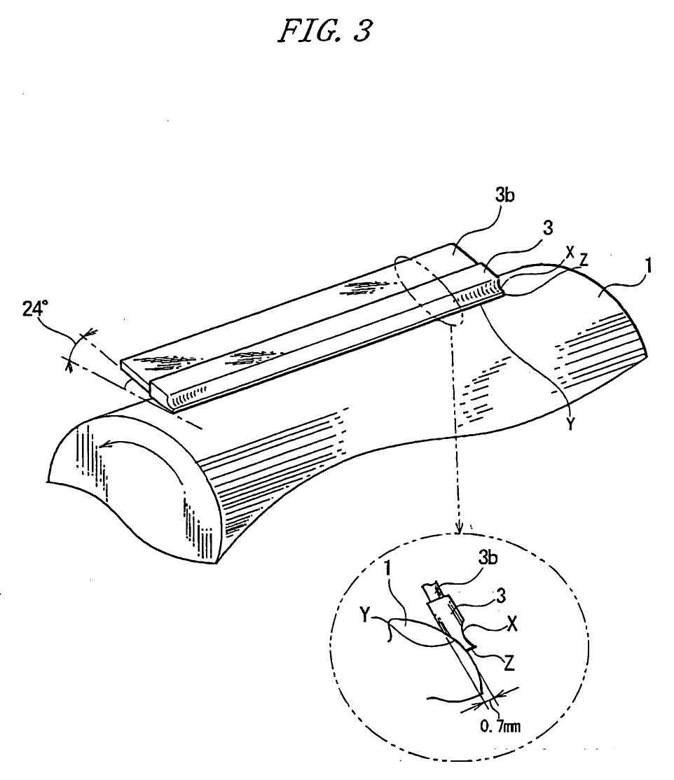

The cleaning blade 3 is set so that an abutment angle with relative to the photosensitive drum 1 as shown in FIG. 3 is 24 degree and an amount of intrusion into the photosensitive drum 1 is 0.7 mm. At this time, a linear pressure of the cleaning blade 3 is 35 g/cm.

Thus, according to the above setting, defects of cleaning and occurrence of detachment of the blade will be prevented while a paper is passing through predetermined portions.

Generally speaking, while a paper is passing through predetermined portions, the toner 10 intervene's at an edge portion of the cleaning blade 3 so as to serve as a lubricant, resulting in that there is little occurrence of detachment of the blade 3. However at the using initial time when the toner 10 does not intervene thereat, a frictional coefficient is great between the cleaning blade 3 and the photosensitive drum 1, resulting in that possibility of occurrence of detachment of the blade 3 becomes larger.

Thus, in the present embodiment, a lubricant agent 11 is coated at the abutment portion between the photosensitive drum 1 and the cleaning blade 3. Here, the lubricant agent 11 is made by blending silicone resin fine powder being insulating fine particles (e.g., the above-mentioned Tospearl) and metallic compounds being conductive fine particles.

The metallic compositions are for example directed to metallic fine powder such as Cu, Au, Ag, Al, and Ni; and conductive fine powder made of metallic compounds such as zinc oxide, titanium oxide, tin oxide, aluminum oxide, indium oxide, silicon oxide, magnesium oxide, barium oxide, molybdenum oxide, ferric oxide, tungstic oxide and composite oxides using any of them.

Above all, if the metallic composition includes one oxide of at least one kind selected from zinc oxide, tin oxide, and titan oxide, it is preferable on the point that resistance (volume resistivity) of the metallic composition fine particles can be lower.

Also, in order to control resistance of metallic composition fine particles and the like, fine particles of metallic oxide including atom material such as Antimony and Aluminum and fine particles each whose surface has a conductive material as metallic composition fine particles. For example, they are fine particles of zinc oxide including aluminum atoms or fine particles of tin oxide including antimony atoms. Then, in the present embodiment, it is more preferable that a reduction-processed type tin oxide is used as metallic composition fine particles. That's why resistance of the reduction-processed type tin oxide can be controlled.

Thus, therein, the lubricant agent 11 is used, in which silicone resin fine powder being insulating fine particles (e.g. the above-mentioned Tospearl) and metallic composition fine particles are blended. And by using the lubricant agent 11, it becomes possible that detachment of the cleaning blade 3 is prevented and adhesion strength between the cleaning blade 3 and coating agent is enhanced.

In the present embodiment, Tospearl and the reduction-processed type tin oxide are concretely used as the lubricant agent 11. Hereinafter, description will be explained about this case.

A median size (diameter) (D50) by volume reference of Tospearl particles is 0.2 to 1.0 μm while a median size (D50) by volume reference of the reduction-processed type tin oxide is 0.4 to 4.0 μm.

D10, D50, and D90of Tospearl particles and metallic composition fine particles are measured as follows.

A liquid module is mounted to a laser diffraction type particle distribution measurement apparatus. “LS-230 type” (produced by COULTER Co.), in which the measurement range is defined by particle size range of 0.04 to 2000 μm and D10, D50, and D90of particles to be measured are calculated by a particle distribution to be obtained by volume reference. After particles whose weight is about 10 mg are added to methanol 10 ml, an ultrasonic distributor disperses this solvent for two minutes, measurement is once repeatedly performed for 90 minutes. Here, D10, D50and D90are respectively defined by that integration of volumes of particles calculated from a smaller particles size side arrives at 10%, 50%, and 90% with relative to a total integration thereof.

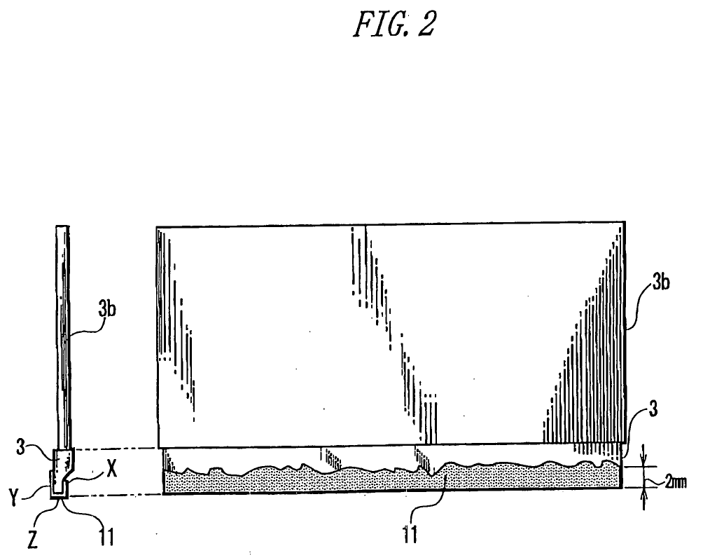

In a method of coating the lubricant agent 11 onto the cleaning blade 3, Tospearl particles and reduction-processed type tin oxide particles are blended into HFE and dispersed thereinto by a ratio of 5% with relative to the total amount. This blending and dispersed one is coated on an edge of the cleaning blade 3 by substantially 2 mm width as shown in FIG. 2. Namely, the blending and dispersed one is coated on a lateral portion Z perpendicularly connected to both flat portions X and Y being mutually opposed and the flat portions X and Y.

The adhesive strength between the cleaning blade 3 and the lubricant agent 11 can be enhanced and detachaent of the blade 3 can be prevented by coating the lubricant agent 11 thereon. Namely, it is prevented that Tospearl being insulating particles are electrostatically agglutinated by a state that existence of particles of reduction-processed tin oxide becomes a hindrance. Therefore, particles of Tospearl are electrostatically agglutinated, namely not enlarged, so that the particles of Tospearl do not drop off and lubricity of the blade 3 is maintained. If the reduction-processed type tin oxide particles are respectively under a range of 0.4 to 4.0 μm, the Tospearl particles will be easy to electrostatically agglutinate. On the other hand, If the reduction-processed type tin oxide particles are respectively over a range of 0.4 to 4.0 μm, there will be no effect of lublicity. Especially, if particle size at D50 by a volume reference of the reduction-processed type tin oxide particles is larger than particle size at D50 by a volume reference of Tospearl, an effect is great that the electrostatic agglegation is prevented. That's why it becomes difficult for Tospearl particles to move, so that Tospearl particles cannot be electrostatically agglutinated because the particle size of each of the reduction-processed type tin oxide particles is larger than that of Tospearl particles. As a preferable specific range, particle size at D50 by a volume reference of particles of Tospearl lies in a range of 0.6 to 0.8 μm and particle size at D50 by a volume reference of the reduction-processed type tin oxide particles lies in a range of 1.0 to 2.0 μm.

Also it is preferable that a proper surface treatment is applied to metallic composition fine particles such as the reduction-processed type tin oxide particles, and the applied particles are used on the point of view that the applied particles are splendidly dispersed into a solvent (such as HFE). For example, as a representative example of such a proper surface treatment for metallic composition fine particles, there is a hydrophobical process. If a processing agent for such a hydrophobical process is made of a silane composition, water-shedding is splendid and most preferable.

A process speed of an electrophotographic type image forming apparatus used in this experiment is 94 mm/sec. Also this apparatus is constituted as shown in FIG. 1, which is above-mentioned.

Here, an OPC drum having a diameter of 30 mm is used as the photosensitive drum 1. On the other hand, the charging roller 2 is made to abut onto the photosensitive drum 1, adding pressure thereto by a total added pressure of 9.8 N using a spring and rotated corresponded to the rotation of the photosensitive drum 1. DC voltage of −1150 V is applied to the charging roller 2 so that the roller 2 has −600 v corresponding to an aimed voltage Vd of the photosensitive body.

Hereinafter, description will be explained about a ratio of blending of particles of Tospearl of the lubricant agent 11 to the reduction-processed type tin oxide particles.

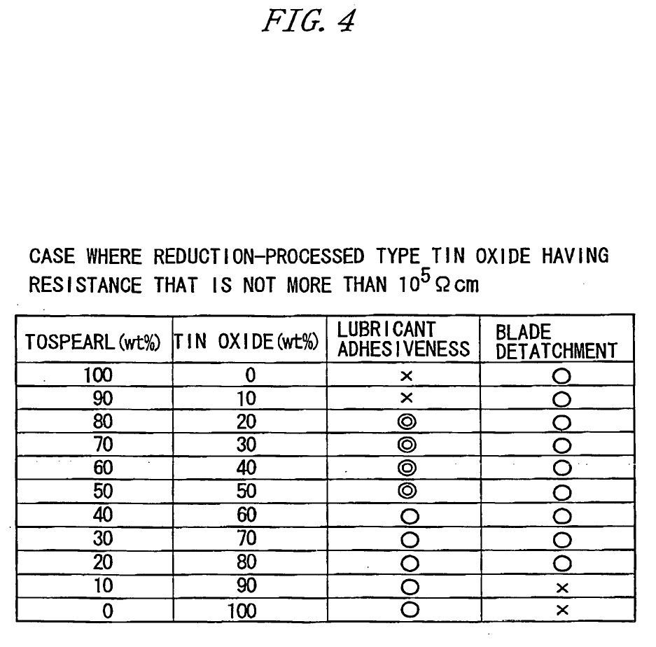

As shown in FIG. 4, if an additive amount of the reduction-processed type tin oxide particles having resistance not less than 10⁵ Ωcm is 20 to 80% (% by weight: wt %) with relative to a total amount of the lubricant agent 11, adhesive strength between the cleaning blade 3 and the lubricant agent 11 is enhanced and detachment of the blade 3 can be prevented.

Deterioration of the adhesive strength is owing to aggregation of the lubricant agent 11 after coating. The aggregation allows the lubricant agent 11 to be collected, and the collected one is detached from the cleaning blade 3. Especially, aggregation is advanced for 72 hours after coating and after that the aggregation becomes constant.

Therefore the reduction-processed type tin oxide particles and Tospearl particles are blended, so that electrostatic aggregation after coating can be prevented and the adhesive strength is enhanced. Accordingly, also in this experiment, 100 sheets of paper were continuously passed through the apparatus for 72 hours after coating, and a condition or detachment of lubricant agent 11 from the cleaning blade 3 was confirmed.

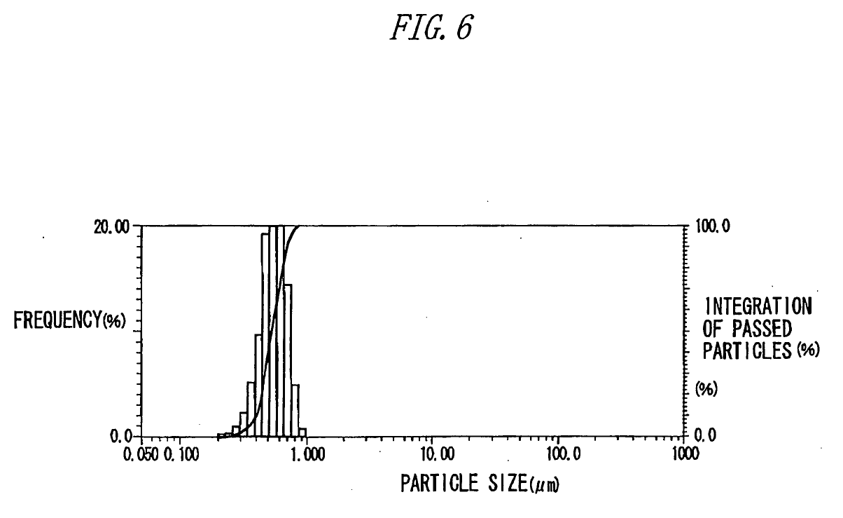

A little amount of detachment was recognized, though there is no problem from a point of view of image quality when the additive amount of reduction-processed type tin oxide particles was defined by 50 to 80% (wt %). From this point, there is no practical problem, if the additive amount of reduction-processed type tin oxide particles was defined by 20 to 80% (wt %). On the other hand, it is more preferable that the additive amount of reduction-processed type tin oxide particles was defined by 20 to 50% (wt %) on the point of view of the detachment property of the lubricant agent 11. Particle size distribution in 72 hours after coating if a ratio of an additive amount of the reduction-processed type tin oxide particles having resistance not more than 10⁵ Ωcm to an amount of Tospearl particles is 4 to 6 is shown in FIG. 6.

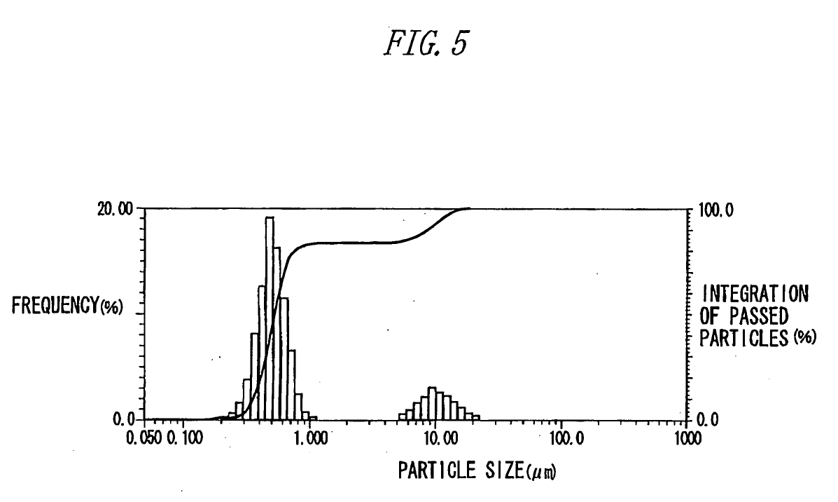

Particle size distribution in 72 hours after coating if only Tospearl is coated thereon is shown in FIG. 5. Upon measuring the particle size distribution, a liquid module is mounted to an above-mentioned laser diffraction type particle size distribution measuring apparatus “LS-230 type” (Coulter, Inc.), in which a measuring range of particle sizes is 0.04 to 2000 μm and thus a particle size distribution to be measured is measured by a volume reference.

In the measurement of the particle size distribution by a volume reference, the lubricant agent 11 detached from the cleaning blade 3 by substantially 10 mg is added to HFE by 10 ml. After dispersing it, using a distributed machine “US-1 type” (by NND K.K.), measurement is performed under the condition that the measuring time is 90 seconds and the measuring time is once. As a result, it was recognized that there was no electrostatic aggregation in the lubricant agent 11 in which the reduction-processed type tin oxide particles having resistance not more than 10⁵ Ωcm and Tospearl particles were dispersed.

D10, D50, and D90of the lubricant agent 11 in which the reduction-processed type tin oxide particles having resistance not more than 10⁵ Ωcm and Tospearl particles, respectively are 0.39 to 0.45 μm, 0.51 to 058 μm, and 0.67 to 0.77 μm.

Hereinafter, description will be explained about resistance of the reduction-processed type tin oxide particles.

Note that resistance of particles is measured as below.

A cylindrical metallic cell is filled with sample. Next, electrodes are arranged above and below the sample so as to contact the sample. A load of 686 kPa (7 kgf/cm²) is added onto the above electrode. In this condition, a voltage V is applied between the above and below electrodes. The resistance (volume resistivity RV) relating to the present invention is measured from current I (A) that flows at this time. Then, if an electrode area and the sample thickness are respectively defined by S (cm²) and M (cm), following equation is satisfied:

RV (Ωcm)=100V multiplied by S (cm²)/I (a)/M (cm)

In the present embodiment, under a condition that a contact area between one of the electrodes and the sample is 2.26 cm² and the voltage V=100 V, the measurement is carried out.

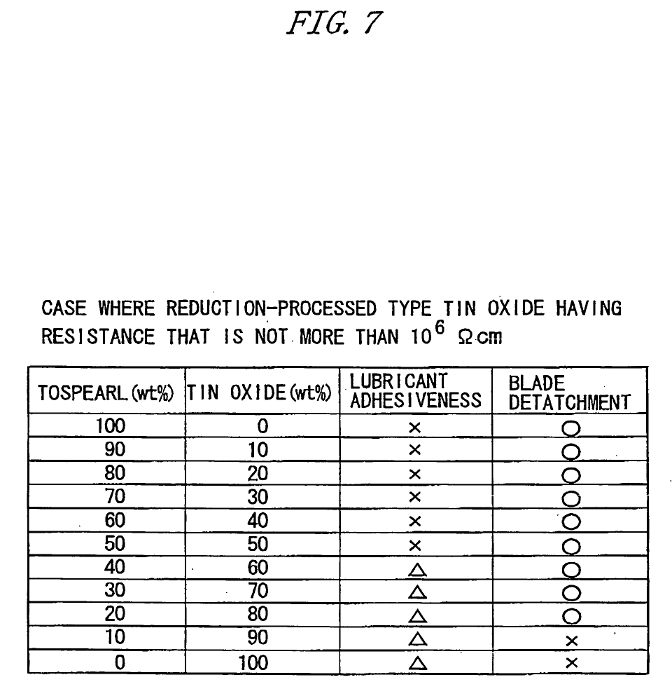

As shown in FIG. 7, in the reduction-processed type tin oxide particles having resistance not less than 10⁵ Ωcm, the adhesive strength was not enhanced. Therefore it is indispensable to form low resistance in order to enhance adhesive strength.

Accordingly, as apparent from FIG. 4 and FIG. 7, it is optimum that resistance of reduction-processed type tin oxide particles is not more than 10⁵ Ωcm.

As above-explained, in the present intention, it can be prevented that the cleaning blade is detached corresponding to motion the electrophotographic photosensitive body. Also, it can be prevented that an electrophotographic photosensitive body cannot be sufficiently charged by the charging roller by attaching insulating particles coated on the abutment portion of the abutment portion that abuts on the electrophotographic photosensitive body onto the electrophotographic photosensitive body. Also, it is possible to enhance adhesiveness between the cleaning blade and insulating particles that was coated on an abutment portion of the cleaning blade and the abutment portion is a portion that abuts on the electrophotographic photosensitive body.

What is claimed is:

1. A cleaning blade for removing remaining developer on an electrophotographic photosensitive body used for an image forming apparatus comprising:,
an abutment portion that abuts on said electrophotographic photosensitive body, lubricant including insulating particles and conductive particles being coated on said abutment portion,
wherein a particle size of each of said insulating particles at D50 by a volume regarded as a reference lies in a range of 0.2 to 1.0 μm and a particle size of each of said conductive particles at D50 by a volume regarded as a reference lies in a range of 0.4 to 4.0 μm, said D50 being defined by that integration of volumes of particles calculated from a smaller particles size side arrives at 50% with relative to a total integration thereof.

2. The cleaning blade as claimed in claim 1, wherein said insulating particles are made of silicone resin powder.

3. The cleaning blade as claimed in claim 1 or 2, wherein said conductive particles are made of reduction-processed type tin oxide.

4. The cleaning blade as claimed in claim 1, wherein said conductive particle is hydrophobically processed.

5. The cleaning blade as claimed in claim 1, wherein said particle size of each of said conductive particles at D50 by the volume regarded as a reference lies in a range being larger than a range of said particle size of each of said insulating particles at D50 by the volume regarded as a reference.

6. The cleaning blade as claimed in claim 1, wherein said particle size of said insulating particles at D50 by the volume regarded as a reference lies in a range of 0.6 to 0.8 μm, while said particle size of said conductive particles at D50 by the volume regarded as a reference lies in a range of 1.0 to 2.0 μm.

7. The cleaning blade as claimed in claim 1, wherein resistivity by volume of said conductive particles is not more than 10⁵ Ωcm, and an additive amount of said conductive particle is an amount of 20 to 80% with relative to a total weight of said lubricant.

8. The cleaning blade as claimed in claim 7, wherein an additive amount of said conductive particle is an amount of 20 to 50% with relative to a total weight of said lubricant.

9. A cleaning device used for an image forming apparatus comprising:
a cleaning blade for removing said remaining developer on said electrophotographic photosensitive body; and
an abutment portion that abuts on said electrophotographic photosensitive body, lubricant including insulating particles and conductive particles being coated on said abutment portion,
wherein a particle size of each of said insulating particles at D50 by a volume regarded as a reference lies in a range of 0.2 to 1.0 μm and a particle size of each of said conductive particles at D50 by a volume regarded as a reference lies in a range of 0.4 to 4.0 μm, said D50 being defined by that integration of volumes of particles calculated from a smaller particles size side arrives at 50% with relative to a total integration thereof.

10. The cleaning device as claimed in claim 9, wherein said insulating particle is made of silicone resin powder.

11. The cleaning device as claimed in claim 9 or 10, wherein said conductive particle is made of reduction-processed type tin oxide.

12. The cleaning device as claimed in claim 9, wherein said conductive particle is hydrophobically processed .

13. The cleaning device as claimed in claim 9, wherein said particle size of each of said conductive particles at D50 by the volume regarded as a reference lies in a range being larger than a range of said particle size of each of said insulating particles at D50 by the volume regarded as a reference.

14. The cleaning device as claimed in claim 9, wherein said particle size of said insulating particles at D50 by the volume regarded as a reference lies in a range of 0.6 to 0.8 μm, while said particle size of said conductive particles at D50 by the volume regarded as a reference lies in a range of 1.0 to 2.0 μm.

15. The cleaning device as claimed in claim 9, wherein resistivity by volume of said conductive particles is not more than 10⁵ Ωcm, and an additive amount of said conductive particle is an amount of 20 to 80% with relative to a total weight of said lubricant.

16. The cleaning device as claimed in claim 15, wherein an additive amount of said conductive particle is an amount of 20 to 50% with relative to a total weight of said lubricant.

17. A process cartridge attachable to a body of an image forming apparatus comprising:
an electrophotographic photosensitive body;
a charging means for working on said electrophotographic photosensitive body;
a cleaning blade for removing said remaining developer on said electrophotographic photosensitive body; and
an abutment portion that abuts on said electrophotographic photosensitive body, lubricant including insulating particles and conductive particles being coated on said abutment portion, wherein a particle size of each of said insulating particles at D50 by a volume regarded as a reference lies in a range of 0.2 to 1.0 μm and a particle size of each of said conductive particles at D50 by a volume regarded as a reference lies in a range of 0.4 to 4.0 μm, said D50 being defined by that integration of volumes of particles calculated from a smaller particles size side arrives at 50% with relative to a total integration thereof.

18. The process cartridge as claimed in claim 17, wherein said insulating particle is made of silicone resin powder.

19. The process cartridge as claimed in claim 17 or 18, wherein said conductive particle is made of reduction-processed type tin oxide.

20. The process cartridge as claimed in claim 17, wherein said conductive particle is hydrophobically processed.

21. The process cartridge as claimed in claim 17, wherein said particle size of each of said conductive particles at D50 by the volume regarded as a reference lies in a range being larger than a range of said particle size of each of said insulating particles at D50 by the volume regarded as a reference.

22. The process cartridge as claimed in claim 17, wherein said particle size of said insulating particles at D50 by the volume regarded as a reference lies in a range of 0.6 to 0.8 μm, while said particle size of said conductive particles at D50 by the volume regarded as a reference lies in a range of 1.0 to 2.0 μm.

23. The process cartridge as claimed in claim 17, wherein resistivity by volume of said conductive particles is not more than 10⁵ Ωcm, and an additive amount of said conductive particle is an amount of 20 to 80% with relative to a total weight of said lubricant.

24. The process cartridge as claimed in claim 23, wherein an additive amount of said conductive particle is an amount of 20 to 50% with relative to a total weight of said lubricant.

25. An image forming apparatus for forming an image on a recording medium comprising;
(i) a cleaning device used for said image forming apparatus having a cleaning blade for removing said remaining developer on said electrophotographic photosensitive body; and an abutment portion that abuts on said electrophotographic photosensitive body, lubricant including insulating particles and conductive particles being coated on said abutment portion,
wherein a particle size of each of said insulating particles at D50 by a volume regarded as a reference lies in a range of 0.2 to 1.0 μm and a particle size of each of said conductive particles at D50 by a volume regarded as a reference lies in a range of 0.4 to 4.0 μm, D50 being defined by that integration of volumes of particles calculated from a smaller particles size side arrives at 50% with relative to a total integration thereof; and
(ii) a carrying means for carrying said recording medium.

26. An image formation apparatus for forming an image onto a recording medium comprising:
(i) an attachment portion, detachably attached to a process cartridge;
(ii) said process cartridge attached to said attachment portion that includes an electrophotographic photosensitive body; a charging means for working on said electrophotographic photosensitive body; a cleaning blade for removing said remaining developer on said electrophotographic photosensitive body; and an abutment portion that abuts on said electrophotographic photosensitive body, lubricant including insulating particles and conductive particles being coated on said abutment portion,wherein a particle size of each of said insulating particles at D50 by a volume regarded as a reference lies in a range of 0.2 to 1.0 μm and a particle size of each of said conductive particles at D50 by a volume regarded as a reference lies in a range of 0.4 to 4.0 μm, said D50 being defined by that integration of volumes of particles calculated from a smaller particles size side arrives at 50% with relative to a total integration thereof; and
(iii) A carrying means for carrying said recording medium.
